(19) United States
(12) Patent Application Publication
(10) Pub. No.: US 2021/0289877 A1
(43) Pub. Date: Sep. 23, 2021

(54) HAT WITH SEAMLESS TOP OF HAT AND MANUFACTURING METHOD THEREFOR

(71) Applicant: Yingqing ZHANG, NANJING (CN)

(72) Inventor: Yingqing ZHANG, NANJING (CN)

(21) Appl. No.: 16/334,085

(22) PCT Filed: Dec. 26, 2017
(86) PCT No.: PCT/CN2017/118613

§ 371 Date: Mar. 18, 2019

(30) Foreign Application Priority Data
Apr. 24, 2017 (CN) 201710271101.6

(51) Int. Cl. A42C 1/04; A42C 1/08

(52) U.S. Cl. CPC A42C 1/04; A42B 1/02; A42C 1/08

(57) ABSTRACT

Disclosed are a hat and a manufacturing method therefor and a hat top shaping device, the hat comprising: a seamless hat top without seams, wherein same is integrally formed by hot stretching a piece of a flat knitted fabric blank containing a vitrifiable petroleum chemical fibre material; and a bongrace jointed to the seamless hat top. The hat top of the hat can save on the production time and cost. The hat top of the hat can be made into various hat types and a variety of raw materials can be selected for same. The hat top of the hat is a hat top without seams, completely fitting the user's headform, and can be made by selecting a breathable material, thereby improving the aesthetics and comfort when wearing same.

### TECHNICAL FIELD

The present disclosure relates to a hat, and more particularly, to a hat having a seamless hat top and a method for manufacturing the same.

### BACKGROUND ART

A hat is a fashion item worn on the head for covering the entire head top. The hat is mainly used to protect a user's head.

Some hats have an extended hat brim in order to block sunlight. The hat may also be used as an accessory for dressing.

In the related art, the hat top of the hat is manufactured by stitching a little fabric that has been cut into a fan shape in many cases.

However, since such a process requires various processes such as cap-piece splitting, bonding and sewing, it is not possible to save the manufacturing time and the manufacturing cost due to the lengthened manufacturing process.

In addition, the manufactured hat top may have seam marks on the exterior, is likely to wrinkles, and may not fully be in close contact with the shape of the user's head, thereby affecting the beauty and the comfort when worn.

CN105747343A discloses the hat in which the hat brim and the hat top are integrally molded, and the hat top of the hat is formed by performing the thermo compression bonding between the positive mold and the negative mold whose shapes are complementary to each other for at least two layers of flexible materials such as a sponge, a TPU, a PPC and a PU.

In order to prevent the occurrence of wrinkles, the material leaves two and three openings before the thermo compression bonding, and the openings are sewed after the thermo compression bonding.

Therefore, the process may not save the manufacturing time and the manufacturing cost because it requires additional processes such as opening and sewing.

Since the manufactured hat top also has seam marks on the exterior, it affects the beauty when worn. In addition, since the hat top made of the materials such as a sponge, a TPU, a PPC and a PU have poor ventilation, it affects the comfort when worn.

CN106049072A discloses the method for manufacturing the polyester felt hat, and the felt hat is formed by extruding two layers of thermally-treated polyester cloth by the pressure between the positive mold and the negative mold whose shapes are complementary to each other.

The method may be used only for manufacturing the felt hat, and the raw material may be selected only with polyester, such that the type and the raw material of the manufactured hat are limited.

The felt hat has to undergo an asynchronous manufacturing process in which the fabric is first heated and then the fabric is pressurized, and it does not help to save the manufacturing time and the manufacturing cost.

### DISCLOSURE

### Technical Problem

An object of the present disclosure is to provide a novel hat and a method for manufacturing the same, which overcome the drawbacks of the related art and have a seamless hat top.

The hat top of the hat of the present disclosure may save the manufacturing time and the manufacturing cost without a number of extra processes such as cap piece splitting, bonding, sewing, or opening, sewing, or extruding the fabric after heating the fabric.

The hat top of the hat of the present disclosure may be manufactured in various types of hats, and may be selected from various raw materials.

The hat top of the hat of the present disclosure is a seamless hat top without seams, is fully in close contact with the shape of the user's head, and is made of a breathable material, thereby improving the beauty and the comfort when worn.

### Technical Solution

A first aspect of the present disclosure includes a seamless hat top without seams and a hat brim bonded to the seamless hat top.

The seamless hat top is integrally molded by hot-stretching one flat knitted fabric blank by a hat top molding machine, and the knitted fabric blank includes a vitrification-available petrochemical fiber material.

Disclosed is a method for manufacturing a hat in which the hat top molding machine includes a punch; a chamber facing the punch and opened to receive the punch; and a fabric holding member for holding the knitted fabric blank in a hat top molding process.

The method for manufacturing the hat includes heating the punch at the temperature equal to or higher than the vitrification temperature of the petrochemical fiber material and lower than the melting point temperature of the petrochemical fiber material; seating so that the central portion of the knitted fabric blank fully covers the opened opening of the chamber; stretching the knitted fabric blank in a shape matching with the outer contour of the punch by moving the punch toward the inside of the chamber through the opening of the chamber until the punch reaches a hat top molding position, while the periphery of the knitted fabric blank is held by the fabric holding member; staying the punch at the hat top molding position for a predetermined time; cooling it by moving the punch from the inside of the chamber, and removing the molded hat top from the upper portion of the chamber; and forming a hat by bonding the hat top and the hat brim together.

Preferably, during the stretching of the knitted fabric blank, a gap is present between the punch and the opening, and the width of the gap is uniformly maintained.

Preferably, the width of the gap is controlled between 0.6 mm and 3 mm during the stretching of the knitted fabric blank.

Preferably, while the punch stays at the hat top molding position, the petrochemical fiber material is converted from a high elastic state to a glass state at the temperature equal to or higher than the vitrification temperature thereof and lower than the melting point temperature thereof so that the knitted fabric blank is fully aligned on the outer contour of the punch.

Preferably, the predetermined time is 30 seconds to 70 seconds.

Preferably, the bonding includes sewing the hat brim and the hat top together.

Preferably, the chamber is heated at the temperature equal to or higher than the vitrification temperature of the petrochemical fiber material and lower than the melting point temperature of the petrochemical fiber material, while heating the punch.

Preferably, before the seating, the knitted fabric blank is cut into the shape and the size suitable for holding the knitted fabric blank by the fabric holding member.

Preferably, before the seating, water is sprayed to the knitted fabric blank.

Preferably, after the cooling and before the bonding, the extra portion of the bottom of the hat top is removed.

Preferably, after the cooling and before the bonding, or after the bonding, a decorative process such as embroidery, printing, transfer thermo compression ironing, or decorative flower sewing for the hat top is performed.

Preferably, after the cooling and before the bonding, a lining is aligned inside the hat top, and the edge of the lining is covered by an adhesive pressing strip to stiffen the hat top.

Preferably, the knitted fabric blank includes a single layer or a plurality of layers of knitted fabrics.

Preferably, the single layer or at least one layer of the plurality of layers of knitted fabrics has the vitrification-available petrochemical fiber material.

Preferably, the single layer or at least one layer of the plurality of layers of knitted fabrics has 5% to 100% contents of the vitrification-available petrochemical fiber material.

Preferably, the vitrification-available petrochemical fiber material is selected from a group consisting of polyester, nylon, spandex, and acrylic.

Preferably, after the cooling and before the bonding, the adhesive pressing strip is fixed to the edge of the bottom of the hat top by an adhesive pressing machine.

Preferably, the adhesive pressing machine includes an upper wheel and a lower wheel, and the upper wheel supplies the adhesive pressing strip to a gap between the upper wheel and the lower wheel, and the lower wheel supplies the edge of the bottom of the hat top to the gap between the upper wheel and the lower wheel.

Preferably, the RPM of the upper wheel and the RPM of the lower wheel are different from each other.

Preferably, the adhesive pressing strip is manufactured by aligning a hot melt adhesive agent by using elastic fabric or banding.

Preferably, the hat brim is made of a stacked material including a TPU material layer, and two fabric layers aligned on the TPU material layer from the upper portion and the lower portion thereof.

A second aspect of the present disclosure discloses a hat manufactured according to the method described in the above-described aspect.

A third aspect of the present disclosure discloses a hat including a seamless hat top without seams integrally molded by hot-stretching one flat knitted fabric blank including a vitrification-available petrochemical fiber material; and a hat brim bonded to the seamless hat top.

Preferably, a lining is aligned inside the hat top, and an adhesive pressing strip for covering the edge of the lining is provided to stiffen the hat top.

Preferably, the hat top is provided with a decorative member such as embroidery, printing, transfer thermo compression ironing, or sewed decorative flower.

Preferably, the hat top is a seamless hat top integrally molded by hot-stretching the flat knitted fabric blank at the temperature equal to or higher than the vitrification temperature of the petrochemical fiber material and lower than the melting point temperature of the petrochemical fiber material.

Preferably, the knitted fabric blank includes a single layer or a plurality of layers of knitted fabrics.

Preferably, the single layer or at least one layer of the plurality of layers of knitted fabrics has the vitrification-available petrochemical fiber material.

Preferably, the single layer or at least one layer of the plurality of layers of knitted fabrics has 5% to 100% contents of the vitrification-available petrochemical fiber material.

Preferably, the vitrification-available petrochemical fiber material is selected from a group consisting of polyester, nylon, spandex, and acrylic.

Preferably, the adhesive pressing strip is fixed to the edge of the bottom of the hat top.

Preferably, the adhesive pressing strip is manufactured by aligning a hot melt adhesive agent by using elastic fabric or banding.

Preferably, the hat brim is made of a stacked material including a TPU material layer, and two fabric layers aligned on the TPU material layer from the upper portion and the lower portion thereof.

A fourth aspect of the present disclosure discloses a hat top molding machine for manufacturing a seamless hat top without seams in which the seamless hat top is integrally molded by hot-stretching one flat knitted fabric blank, and the knitted fabric blank includes a vitrification-available petrochemical fiber material.

The hat top molding machine includes a molding device and a support device, and the molding device includes a base; a punch fixed to the lower portion of the base, and for hot-stretching the knitted fabric blank of the seamless hat top in a desired shape by providing the shape matching with the seamless hat top; and a fabric holding member slidably connected to the base, and for holding the periphery of the hat top knitted fabric blank in a hat top molding process.

The support device is disposed on the vertical lower portion of the molding device, and includes a housing and a chamber inwards recessed and opened from the housing, and the opening of the chamber faces the punch, and the chamber fully receives the punch entering through the opening.

Preferably, in the process of hot-stretching the knitted fabric blank, the punch enters the chamber through the opening, a gap is present between the punch and the opening, and the width of the gap is uniformly maintained.

Preferably, in the process of hot-stretching the knitted fabric blank, the width of the gap is controlled between 0.6 mm and 3 mm.

Preferably, the fabric holding member includes a holding frame for holding the periphery of the hat top knitted fabric blank in the hat top molding process; a guide rod fixed to the holding frame, and for guiding so that the holding frame vertically moves with respect to the base; and a spring device installed between the base and the holding frame.

### Advantageous Effects

The hat top of the hat of the present disclosure may save the manufacturing time and the manufacturing cost without a number of extra processes such as cap piece splitting, bonding, sewing, or opening, sewing, or extruding the fabric after heating the fabric.

The hat top of the hat of the present disclosure may be manufactured in various types of hats, and may be selected from various raw materials.

The hat top of the hat of the present disclosure is a seamless hat top without seams, is fully in close contact with the shape of the user's head, and is made of a breathable material, thereby improving the beauty and the comfort when worn.

### DESCRIPTION OF DRAWINGS

Various aspects and features of the present disclosure are described with reference to the drawings.

FIG. 1 is a perspective diagram of a hat according to the present disclosure.

FIG. 2 is a perspective diagram of a hat top molding machine according to the present disclosure.

FIGS. 3a and 3b are a perspective diagram and a cross-sectional diagram of a molding device of the hat top molding machine according to the present disclosure, respectively.

FIGS. 4a and 4b are a perspective diagram and a cross-sectional diagram of a support device of the hat top molding machine according to the present disclosure, respectively.

FIGS. 5a to 5g are schematic diagrams illustrating steps in which the hat top molding machine according to the present disclosure manufactures the hat top and the hat.

FIG. 6 is a perspective diagram of the hat top manufactured by the hat top molding machine according to the present disclosure.

FIGS. 7a and 7b are a perspective diagram and a side surface diagram of an adhesive pressing machine according to the present disclosure.

FIG. 8 is a perspective diagram of the hat top after the adhesive pressing machine according to the present disclosure aligns an adhesive pressing strip.

### BEST MODE

Hereinafter, embodiments of the present disclosure will be described with reference to the drawings.

It should be understood, however, that the present disclosure is not limited to the details of structures or operating steps described below.

The present disclosure may have other embodiments, and may be practiced or carried out in various forms.

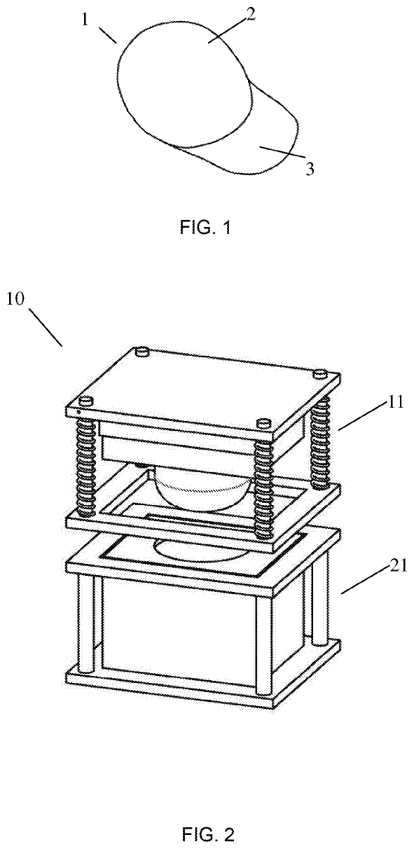

FIG. 1 illustrates a hat 1 including a seamless hat top 2 having no any seams on a main body portion according to an embodiment of the present disclosure, and a hat brim 3 bonded to the seamless hat top 2 by a process such as sewing.

The seamless hat top 2 is integrally molded by a hot stretching process of a hat top molding machine 10 (see FIG. 2, which will be described in detail below), and may be an approximately hemispherical shape, an approximately semi-elliptical shape, an approximately cylindrical shape, or an approximately truncated cone shape.

If necessary, it may also have various shapes, for example, an animation shape suitable for a child. The hat brim 3 may be manufactured in a duck tongue shape, a truncated cone shape or any other suitable shape as long as it may be bonded to the hat top 2.

As described above, the related art forms a hat top by pressurizing or extruding the material previously seated in the gap between a positive mold and a negative mold by the pressure between the positive mold and the negative mold whose shapes are complementary to each other.

However, the present disclosure uses the tensile force of a punch of the hat top molding machine (a corresponding die is not required) in order to hot-stretch one flat fabric in a shape matching the outer contour of the punch.

For this purpose, the seamless hat top 2 of the present disclosure selects elastic knitted fabric rather than non-elastic woven fabric.

In addition, in order to better align the knitted fabric on the outer contour of the punch in the hot stretching process, the knitted fabric may preferably include 5% to 100% contents of a vitrification-available petrochemical fiber material such as polyester, nylon, spandex, or acrylic.

The hat brim 3 may be selected and blended with any suitable fabric.

As illustrated in FIG. 2, the seamless hat top 2 is integrally molded by the hat top molding machine 10.

The hat top molding machine 10 includes a molding device 11 and a support device 21 disposed at the vertical lower portion of the molding device 11.

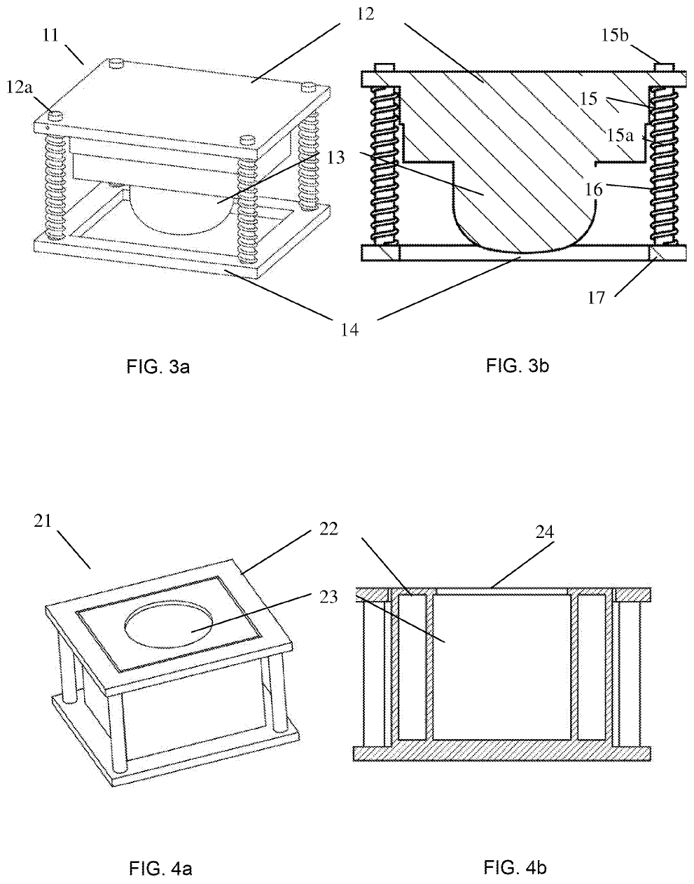

Referring to FIGS. 3a and 3b, the molding device 11 is used for molding the seamless hat top 2 by a hot stretching method, and includes a base 12, a punch 13 and a fabric holding member 14. The base 12 guides so that the entire molding device 11 is vertically moved between an initial position of the upper portion thereof and a hat top molding position of the lower portion thereof by a driving device (not illustrated).

The punch 13 is fixed to the lower portion of the base 12, and has a shape matching with the hat top 2 in order to hot-stretch a fabric blank (the blank means an unfinished cloth, a raw material before a product, or the like) of the hat top in a desired shape.

A heating device for heating the punch 13, such as a resistive heat-generating wire, may be installed inside or outside the punch 13.

The fabric holding member 14 is for holding the periphery of the hat top fabric blank on the uppermost surface of the support device 21 in the hat top molding process, and includes a guide rod 15, a spring device 16, and a holding frame 17.

The guide rod 15 includes a straight-line rod main body 15a having a uniform size and a flange 15b horizontally protruded from the upper end of the rod main body 15a or other protruded members.

The rod main body 15a has a smaller size than a through-hole 12a around the base 12, and the flange 15b has a larger size than the through-hole 12a, such that the rod main body 15a may vertically move within the through-hole 12a, but may not pass through the through-hole 12a in the flange 15b.

The holding frame 17 is fixed to the lower end of the rod main body 15a.

The height of the rod main body 15a is calculated from the lower surface of the base 12.

The vertical height of the punch 13 is calculated from the lower surface of the base 12.

Therefore, since the vertical height of the rod main body 15a is greater than the vertical height of the punch 13, at the initial position, the punch 13 is limited within the space formed by the base 12, the guide rod 15, and the holding frame 17.

The spring device 16 is installed between the base 12 and the holding frame 17, and holds the periphery of the hat top fabric blank between the holding frame 17 and the uppermost surface of the support device 21 by contacting with the base 12 in a state where the pressure has been applied thereto to apply the pressure to the holding frame 17.

In a preferred embodiment, the spring device 16 may be a coil spring of the rod main body 15a surrounding the guide rod 15.

Referring to FIGS. 4a and 4b, the support device 21 supports the hat top fabric blank in the hat top molding process, and includes a housing 22 and a chamber 23 inwards recessed and opened from the central portion of the uppermost surface of the housing 22.

An opening 24 of the chamber 23 faces the punch 13, and the chamber 23 may fully receive the punch 13, but it is not necessary to install a die that is complementary to the shape of the punch 13.

The molding device 11 uniformly holds the width of the gap between the opening 24 of the chamber 23 and the outer contour of the punch 13 so that the punch 13 may uniformly stretch the hat top fabric blank downwards in the downward guide process to the hat top molding position by the driving device.

In a preferred embodiment, the heating device (not illustrated) for heating the chamber 23 is installed inside or outside the support device 21.

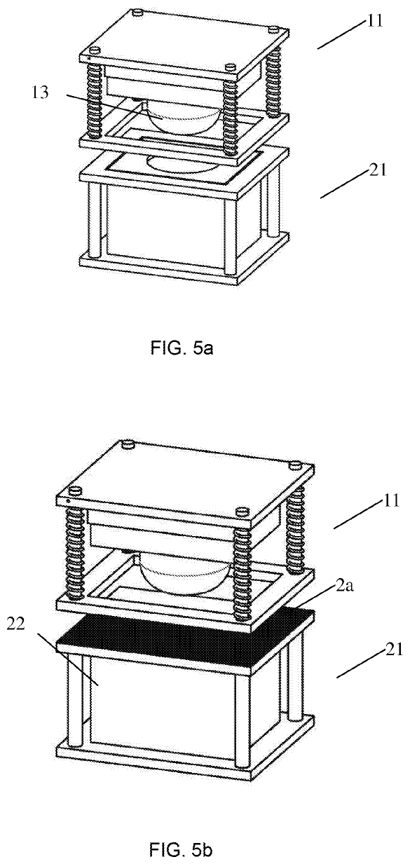

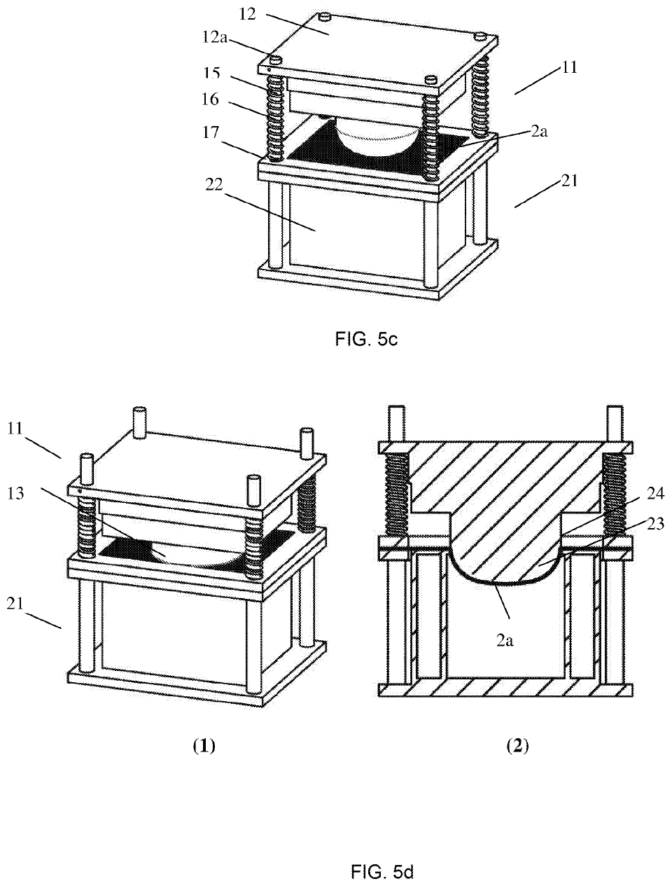

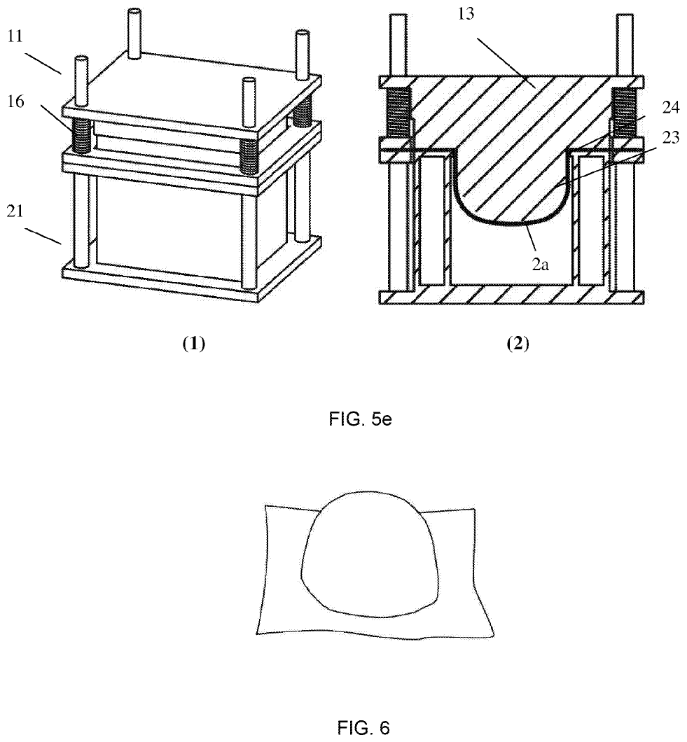

Hereinafter, a method for manufacturing the seamless hat top 2 by the hat top molding machine 10 will be described with reference to FIGS. 5a to 5g.

First, a fabric suitable for manufacturing the seamless hat top 2 is selected.

As described above, the hat top fabric blank 2a of the seamless hat top 2 may select a single layer or a plurality of layers of flat knitted fabrics.

When the hat top fabric blank 2a is a single layer of knitted fabric, the single layer of knitted fabric includes 5% to 100% of a vitrification-available petrochemical fiber material such as polyester, nylon, spandex, or acrylic.

When the hat top fabric blank 2a is a plurality of layers of knitted fabrics, at least one layer of the plurality of layers of knitted fabrics includes 5% to 100% of a vitrification-available petrochemical fiber material, and other layers may be cotton fabric or other fabrics.

Then, the fabric of the hat top 2 is cut. The hat top fabric blank 2a of the seamless hat top 2 is cut greater than the shape and the size of the holding frame 17 such as a rectangular shape or an elliptical shape so that the holding frame 17 holds the periphery of the hat top fabric blank 2a in the hat top molding process to uniformly enter the hat top fabric blank 2a into the chamber 23 at a controllable speed.

As illustrated in FIG. 5a, the punch 13 is heated at the temperature equal to or higher than the vitrification temperature of the petrochemical fiber material and lower than the melting point temperature of the petrochemical fiber material by the heating device (not illustrated).

In a preferred embodiment, the chamber 23 is heated at the temperature equal to or higher than the vitrification temperature of the petrochemical fiber material and lower than the melting point temperature of the petrochemical fiber material.

When water is sprayed on the hat top fabric blank 2a by using an air brush so that the hat top fabric blank 2a contacts with the heated punch 13, water is sprayed at a high temperature to permeate into the hat top fabric blank 2a so that the whole hat top fabric blank 2a is uniformly heat-transferred, thereby advantageously stabilizing the shape of the hat top 2.

As illustrated in FIG. 5b, the water-sprayed hat top fabric blank 2a is flatly seated on the uppermost surface of the housing 22 of the support device 21 to flatten it, and the central portion of the hat top fabric blank 2a fully covers the opening 24 of the chamber 23.

As illustrated in FIG. 5c, the driving device (not illustrated) of the molding device 11 is operated so that the molding device 11 vertically moves downwards from the initial position thereof toward the support device 21 to be driven until the holding frame 17 contacts with the hat top fabric blank 2a.

Then, the molding device 11 continues to vertically move downwards, and the base 12 applies pressure to the spring device 16 downwards along the guide rod 15 passing through the through-hole 12a.

The pressure of the spring device 16 is applied to the holding frame 17 so that the periphery of the hat top fabric blank 2a may be held between the holding frame 17 and the uppermost surface of the housing 22 to uniformly enter the hat top fabric blank 2a into the chamber 23 at a controllable speed.

As illustrated in FIGS. 5d and 5e, the molding device 11 continues to vertically move downwards, and at this time, the punch 13 begins to contact with the hat top fabric blank 2a and enters into the chamber 23 of the support device 21.

Since the holding frame 17 holds the peripheral portion of the hat top fabric blank 2a, the downward movement of the punch 13 is performed so that the hat top fabric blank 2a is stretched downwards to pass through the opening 24 at a controllable speed to enter into the chamber 23.

As illustrated in FIGS. 5f and 5g, the molding device 11 continues to vertically move downwards until the spring device 16 is fully compressed, and at this time, reaches the hat top molding position of the molding device 11.

The molding device 11 stays in the hat top molding position for a predetermined time such as between 30 seconds and 70 seconds, and the heat amount of the heated punch 13 and the chamber 23 is transferred to the hat top fabric blank 2a.

The petrochemical fiber material (e.g., polyester, nylon, spandex, acrylic, etc.) contained in the hat top fabric blank 2a is converted from a high elastic state to a glass state at the temperature equal to or higher than the vitrification temperature thereof and lower than the melting point temperature thereof.

At this time, the hat top fabric blank 2a is fully aligned on the outer contour of the punch 13, and the hat top 2 matching with the shape of the punch 13 is formed.

After the hat top 2 has been molded, the driving device (not illustrated) is reversely operated so that the molding device 11 is vertically moved upwards from the hat top molding position to be moved to the initial position.

As illustrated in FIG. 6, the hat top 2 is removed from the upper portion of the chamber 23 and naturally cooled, thereby forming the molded hat top 2.

If necessary, the extra portion formed on the bottom of the hat top 2 may be removed.

In an embodiment, the extra portion of the bottom of the hat top 2 may be removed by an adhesive pressing machine 30, and an adhesive pressing strip may be fixed to the edge of the bottom of the hat top 2.

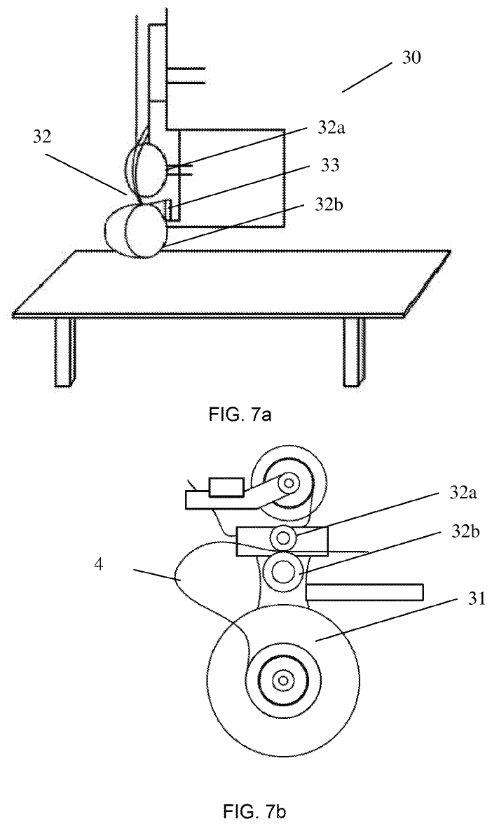

As illustrated in FIGS. 7a and 7b, the adhesive pressing machine 30 includes an adhesive pressing strip storage part 31, an adhesive pressing strip compression part 32, and a cutter 33.

An adhesive pressing strip 4 is manufactured by aligning a hot melt adhesive agent by using elastic fabric.

The width thereof is preferably 6 mm, and the adhesive pressing strip storage part 31 stores the unused wound adhesive pressing strip 4.

The adhesive pressing strip compression part 32 includes an upper wheel 32a and a lower wheel 32b.

By driving the driving device (not illustrated), the upper wheel 32a supplies the adhesive pressing strip 4 from the adhesive pressing strip storage part 31 to the gap between the upper wheel and the lower wheel, and the lower wheel 32b supplies the edge of the bottom of the hat top 2 to the gap between the upper wheel and the lower wheel.

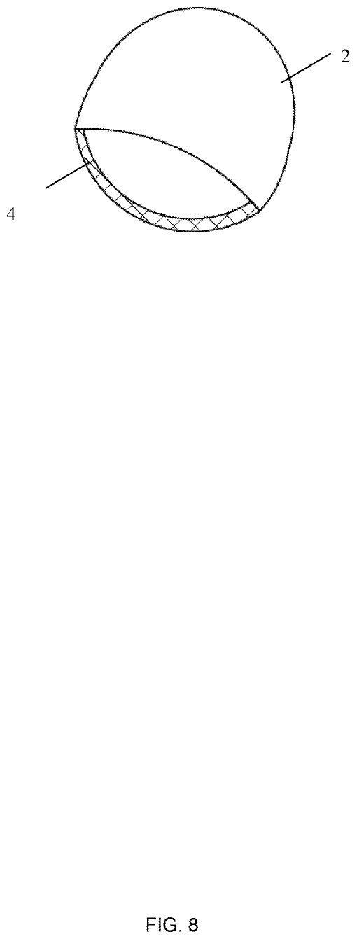

As illustrated in FIG. 8, the adhesive pressing strip 4 is thermally welded and fixed to the edge of the bottom of the hat top 2 by the pressure between the upper wheel 32a and the lower wheel 32b.

Since the circumference of the bottom of the hat top 2 is usually greater than the actual required circumference thereof, the desired circumference of the hat top may be implemented by the difference of the RPMs between the upper wheel 32a and the lower wheel 32b,

in the conventional method, banding is sewn on the bottom of the hat by a sewing machine or a serger, which does not control the circumference of the hat very well.

While, before or after the adhesive pressing strip 4 is thermally welded and fixed to the edge of the bottom of the hat top 2, the extra portion of the bottom of the hat top 2 is removed by the cutter 33.

In an embodiment, a decorative process such as embroidery, printing, transfer thermo compression ironing, or decorative flower sewing for the molded hat top 2 is performed.

In an embodiment, a lining may be aligned on the front of the inner surface of the molded hat top 2, and the edge of the lining is covered by the adhesive pressing strip to stiffen the hat top 2.

The hat brim 3 is made of a stacked material including a TPU material layer and two fabric layers aligned on the TPU material layer from the upper portion and the lower portion thereof.

As illustrated in FIG. 1, one complete hat 1 is formed by cutting the stacked material in a shape of the hat brim to bind around it, then sewing the hat top 2 and the desired hat brim 3 together, and adding an elastic bead strip. The conventional hat brim is made of hard plastic, which may not be folded, and the folded marks are easy to occur, but

the hat brim 3 has excellent elastic recovery to be foldable together with the hat top 2, and thereby the hat 1 may be carried in a plastic container or other packing bags, and after unfolded, the hat 1 is restored to its original shape, thereby maintaining the good shape of the hat.

In the method, the molding of the hat top may save the manufacturing time and the manufacturing cost without the cap piece splitting, bonding and sewing process, or opening sewing process, or the process of extruding the fabric after heating the fabric of the related art.

The hat top of the hat of the present disclosure may be manufactured in various types of hats, and may be selected from various raw materials.

In addition, in the hat top stretching process, the width of the gap between the punch 13 and the opening 24 is uniformly controlled between 0.6 mm and 3 mm, such that the punch 13 may uniformly stretch downwards the hat top fabric blank 2a, and the hat top may not be wrinkled.

The hat top manufactured according to the method is a seamless hat top without seams, is fully in close contact with the shape of the user's head, and is made of a breathable material, thereby improving the beauty and the comfort when worn.

Throughout the specification, the description of “one embodiment,” “an alternative embodiment,” “one or a plurality of embodiments,” or “an embodiment” means that at least one embodiment of the present disclosure includes a specific feature, structure, material or characteristic described in the embodiment in connection with the embodiment.

Therefore, words such as “in one or a plurality of embodiments,” “in a specific embodiment,” “in one embodiment,” or “in an embodiment” described in a plurality of positions throughout the specification does not necessarily refer to the same embodiment of the present disclosure.

In addition, the specific feature, structure, material, or characteristic may be combined in any suitable method in one or a plurality of embodiments.

While the present disclosure has been described with reference to specific embodiments, it is to be understood that such embodiments are merely illustrative of the principles and the applications of the present disclosure.

Those skilled in the art of the present disclosure will appreciate that various changes and modifications may be made in the method and the device of the present disclosure without departing from the spirit and scope of the present disclosure.

Accordingly, the present disclosure includes changes and modifications thereof within the scope of the claims and their equivalents.

1. A method for manufacturing a hat,
wherein the hat comprises a seamless hat top without seams and a hat brim bonded to the seamless hat top,
wherein the seamless hat top is integrally molded by hot-stretching one flat knitted fabric blank by a hat top molding machine,
wherein the knitted fabric blank comprises a vitrification-available petrochemical fiber material, and
wherein the hat top molding machine comprises
a punch;
a chamber facing the punch and opened to receive the punch; and
a fabric holding member for holding the knitted fabric blank in a hat top molding process,
the method for manufacturing the hat, comprising:
heating the punch at the temperature equal to or higher than the vitrification temperature of the petrochemical fiber material and lower than the melting point temperature of the petrochemical fiber material;
seating so that the knitted fabric blank fully covers the opened opening of the chamber;
stretching the knitted fabric blank in a shape matching with the outer contour of the punch by moving the punch toward the inside of the chamber through the opening of the chamber until the punch reaches a hat top molding position, while the periphery portion of the knitted fabric blank is held by the fabric holding member;
staying the punch at the hat top molding position for a predetermined time;
cooling it by moving the punch from the inside of the chamber to the outside thereof, and removing the molded hat top from the upper portion of the chamber; and
forming a hat by bonding the hat top and the hat brim together.

2. The method for manufacturing the hat of claim 1,
wherein during the stretching of the knitted fabric blank, a gap is present between the punch and the opening, and the width of the gap is uniformly maintained.

3. The method for manufacturing the hat of claim 2,
wherein the width of the gap is controlled between 0.6 mm and 3 mm during the stretching of the knitted fabric blank.

4. The method for manufacturing the hat of claim 1,
wherein while the punch stays at the hat top molding position, the petrochemical fiber material is converted from a high elastic state to a glass state at the temperature equal to or higher than the vitrification temperature thereof and lower than the melting point temperature thereof so that the knitted fabric blank is fully aligned on the outer contour of the punch.

5. The method for manufacturing the hat of claim 1,
wherein the predetermined time is 30 seconds to 70 seconds.

6. (canceled)

7. The method for manufacturing the hat of claim 1,
wherein the chamber is heated at the temperature equal to or higher than the vitrification temperature of the petrochemical fiber material and lower than the melting point temperature of the petrochemical fiber material, while heating the punch.

8. (canceled)

9. The method for manufacturing the hat of claim 1,
wherein before the seating, water is sprayed to the knitted fabric blank.

10. (canceled)

11. The method for manufacturing the hat of claim 1, further comprising a decorative process such as embroidery, printing, transfer thermo compression ironing, or decorative flower sewing for the hat top, after the cooling and before the bonding, or after the bonding.

12. The method for manufacturing the hat of claim 1,
wherein after the cooling and before the bonding, a lining is aligned inside the hat top, and the edge of the lining is covered by an adhesive pressing strip to stiffen the hat top.

13. The method for manufacturing the hat of claim 1,
wherein the knitted fabric blank comprises a single layer or a plurality of layers of knitted fabrics.

14. The method for manufacturing the hat of claim 13,
wherein the single layer or at least one layer of the plurality of layers of knitted fabrics has the vitrification-available petrochemical fiber material.

15. (canceled)

16. The method for manufacturing the hat of claim 1,
wherein the vitrification-available petrochemical fiber material is selected from a group consisting of polyester, nylon, spandex, and acrylic.

17. The method for manufacturing the hat of claim 1,
wherein after the cooling and before the bonding, the adhesive pressing strip is fixed to the edge of the bottom of the hat top by an adhesive pressing machine.

18. The method for manufacturing the hat of claim 17,
wherein the adhesive pressing machine comprises an upper wheel and a lower wheel, and the upper wheel supplies the adhesive pressing strip to a gap between the upper wheel and the lower wheel, and the lower wheel supplies the edge of the bottom of the hat top to the gap between the upper wheel and the lower wheel.

19. (canceled)

20. The method for manufacturing the hat of claim 17,
wherein the adhesive pressing strip is manufactured by aligning a hot melt adhesive agent by using elastic fabric or banding.

21. (canceled)

22. A hat manufactured by the method for manufacturing the hat of claim 1.

23-33. (canceled)

34. A hat top molding machine for manufacturing a seamless hat top without seams in which the seamless hat top is integrally molded by hot-stretching one flat knitted fabric blank, and the knitted fabric blank comprises a vitrification-available petrochemical fiber material, comprising:
a molding device and a support device,
wherein the molding device comprises
a base;
a punch fixed to the lower portion of the base, and for hot-stretching the knitted fabric blank of the seamless hat top in a desired shape by providing the shape matching with the seamless hat top; and
a fabric holding member slidably connected to the base, and for holding the periphery of the hat top knitted fabric blank in a hat top molding process, and
wherein the support device is disposed on the vertical lower portion of the molding device, and comprises a housing and a chamber inwards recessed and opened from the housing, and the opening of the chamber faces the punch, and the chamber fully receives the punch entering through the opening.

35. The hat top molding machine of claim 34,
wherein in the process of hot-stretching the knitted fabric blank, the punch enters the chamber through the opening, a gap is present between the punch and the opening, and the width of the gap is uniformly maintained.

36. The hat top molding machine of claim 35,
wherein in the process of hot-stretching the knitted fabric blank, the width of the gap is controlled between 0.6 mm and 3 mm.

37. The hat top molding machine of claim 34,
wherein the fabric holding member comprises
a holding frame for holding the periphery of the hat top knitted fabric blank in the hat top molding process;
a guide rod fixed to the holding frame, and for guiding so that the holding frame vertically moves with respect to the base; and
a spring device installed between the base and the holding frame.
